(19) United States
(12) Patent Application Publication
(10) Pub. No.: US 2025/0383957 A1
(43) Pub. Date: Dec. 18, 2025

(54) STORAGE DEVICE AND OPERATING METHOD OF STORAGE DEVICE

(71) Applicant: SAMSUNG ELECTRONICS CO., LTD., Suwon-si (KR)

(72) Inventors: Min-Ki Song, Suwon-si (KR); Junho Shin, Suwon-si (KR); Dong-Min Shin, Suwon-si (KR); Dae-Yeol Yang, Suwon-si (KR); Kijun Jeon, Suwon-si (KR); Bohwan Jun, Suwon-si (KR); Youngjun Hwang, Suwon-si (KR)

(21) Appl. No.: 19/047,257

(22) Filed: Feb. 6, 2025

(30) Foreign Application Priority Data
Jun. 14, 2024 (KR) 10-2024-0077700

(51) Int. Cl. G06F 11/10

(52) U.S. Cl. CPC G06F 11/1044

(57) ABSTRACT

An example storage device includes a nonvolatile memory device and a memory controller. The memory controller includes an internal buffer storing first data read from the nonvolatile memory device and an error correction code block reading the first data from the internal buffer and correcting an error of the first data. The error correction code block performs an error correction operation of performing an error correction loop for the data and an estimation operation of estimating a residual error from second data experiencing the error correction loop. When the number of errors estimated in the estimation operation is greater than a threshold value, the error correction code block further performs the error correction operation and the estimation operation.

### CROSS-REFERENCE TO RELATED APPLICATION

This application claims priority under 35 U.S.C. § 119 to Korean Patent Application No. 10-2024-0077700 filed on Jun. 14, 2024, in the Korean Intellectual Property Office, the disclosures of which are incorporated by reference herein in their entireties.

### BACKGROUND

A storage device stores data under control of a host device, such as a computer, a smartphone, or a smart pad. The storage device includes a device for storing data on a magnetic disk, such as a hard disk drive (HDD), or a device for storing data in a semiconductor memory, in particular, a nonvolatile memory, such as a solid state drive (SSD) or a memory card.

The nonvolatile memory includes a read only memory (ROM), a programmable ROM (PROM), an electrically programmable ROM (EPROM), an electrically erasable and programmable ROM (EEPROM), a flash memory, a phase-change random access memory (PRAM), a magnetic RAM (MRAM), a resistive RAM (RRAM), or a ferroelectric RAM (FRAM).

Mobile devices require low-power components. Because a storage device is also used as a component of the mobile device, a low-power storage device is also desired.

### SUMMARY

The present disclosure relates to a storage device with reduced power consumption and an operating method of the storage device.

In some implementations, a storage device includes a nonvolatile memory device and a memory controller that controls the nonvolatile memory device. The memory controller includes an internal buffer that stores first data read from the nonvolatile memory device and an error correction code block that reads the first data from the internal buffer and corrects an error of the first data. The error correction code block performs an error correction operation of performing an error correction loop for the data and an estimation operation of estimating a residual error from second data experiencing the error correction loop. When the number of errors estimated in the estimation operation is greater than a threshold value, the error correction code block further performs the error correction operation and the estimation operation. When the number of errors is smaller than or equal to the threshold value, the error correction code block performs a check operation of checking integrity of third data experiencing the error correction operation and the estimation operation.

In some implementations, an operating method of a storage device which includes a nonvolatile memory device and a memory controller includes reading, at the memory controller, first data from the nonvolatile memory device, performing, at the memory controller, an error correction operation on the first data to generate second data, performing, at the memory controller, an error estimation operation on the second data, performing, at the memory controller, the error correction operation and the error estimation operation, when the number of errors estimated in the error correction operation is greater than a threshold value, and performing, at the memory controller, an integrity estimation operation on the second data, when the number of the errors is smaller than or equal to the threshold value.

In some implementations, a memory system includes a nonvolatile memory device, and a memory controller that controls the nonvolatile memory device. The memory controller includes an internal buffer that stores first data read from the nonvolatile memory device, and an error correction code block that reads the first data from the internal buffer and corrects an error of the first data. The error correction code block performs an error correction operation of performing an error correction loop for the data and an estimation operation of estimating a residual error from second data experiencing the error correction loop. When the number of errors estimated in the error correction operation is greater than a threshold value, the error correction code block further performs the error correction operation and the estimation operation. When the number of the errors is smaller than or equal to the threshold value, the error correction code block further performs a check operation of checking integrity of third data experiencing the error correction operation and the estimation operation and a store operation of storing the third data in the internal buffer. When the number of the estimated errors is greater than the threshold value, the error correction code block omits the check operation. When an error is detected in the check operation, the error correction code block further performs the error correction operation and the estimation operation on the third data.

### BRIEF DESCRIPTION OF THE DRAWINGS

The above and other objects and features of the present disclosure will become apparent by describing in detail implementations thereof with reference to the accompanying drawings.

FIG. 1 illustrates an example of a storage device.

FIG. 2 illustrates an example of an error correction code block.

FIG. 3 illustrates an example of a factor graph showing an operating principle of a decoder.

FIG. 4 illustrates an example of an operating method of an error correction code block.

FIG. 5 illustrates a first example in which an estimator performs an estimation operation.

FIG. 6 illustrates a second example in which an estimator performs an estimation operation.

FIG. 7 is a diagram illustrating a third example in which an estimator performs an estimation operation.

FIG. 8 is a block diagram illustrating an example of a nonvolatile memory device.

FIG. 9 illustrates an example of an operating method of an error correction code block.

FIG. 10 is a diagram illustrating an example of a system.

### DETAILED DESCRIPTION

Below, implementations of the present disclosure will be described in detail and clearly to such an extent that an ordinary one in the art easily carries out the present disclosure.

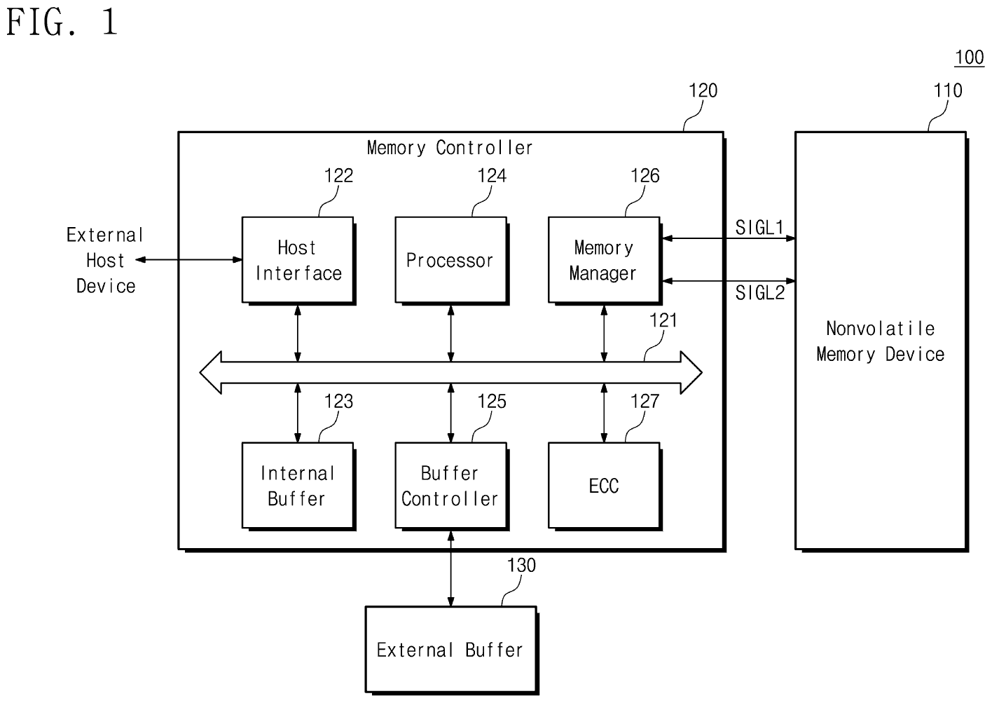

FIG. 1 illustrates an example of a storage device 100. Referring to FIG. 1, the storage device 100 may include a nonvolatile memory device 110, a memory controller 120, and an external buffer 130. The nonvolatile memory device 110 may include a plurality of memory cells. Each of the plurality of memory cells may store two or more bits.

For example, the nonvolatile memory device 110 may include at least one of various nonvolatile memory devices such as a flash memory device, a phase-change memory device, a ferroelectric memory device, a magnetic memory device, and a resistive memory device.

The memory controller 120 may receive various requests for writing data in the nonvolatile memory device 110 or reading data from the nonvolatile memory device 110, from an external host device. The memory controller 120 may store (or buffer) user data communicated with the external host device in the external buffer 130 and may store metadata for managing the storage device 100 in the external buffer 130.

The memory controller 120 may access the nonvolatile memory device 110 through first signal lines SIGL1 and second signal lines SIGL2. For example, the memory controller 120 may transmit a command and an address to the nonvolatile memory device 110 through the first signal lines SIGL1. The memory controller 120 may exchange data with the nonvolatile memory device 110 through the first signal lines SIGL1.

The memory controller 120 may transmit a first control signal to the nonvolatile memory device 110 through the second signal lines SIGL2. The memory controller 120 may receive a second control signal from the nonvolatile memory device 110 through the second signal lines SIGL2.

In some implementations, the memory controller 120 may be configured to control two or more nonvolatile memory devices. The memory controller 120 may provide first signal lines and second signal lines independently for each of the two or more nonvolatile memory devices.

As another example, the memory controller 120 may share first signal lines with the two or more nonvolatile memory devices. The memory controller 120 may share some of second signal lines with the two or more nonvolatile memory devices and may separately provide the others thereof.

The external buffer 130 may include a random access memory. For example, the external buffer 130 may include at least one of a dynamic random access memory, a phase-change random access memory, a ferroelectric random access memory, a magnetic random access memory, and a resistive random access memory.

The memory controller 120 may include a bus 121, a host interface 122, an internal buffer 123, a processor 124, a buffer controller 125, a memory manager 126, and an error correction code (ECC) block 127.

The bus 121 may provide communication channels between the components of the memory controller 120. The host interface 122 may receive various requests from the external host device and may parse the received requests. The host interface 122 may store the parsed requests in the internal buffer 123.

The host interface 122 may transmit various responses to the external host device. The host interface 122 may exchange signals with the external host device in compliance with a given communication protocol. The internal buffer 123 may include a random access memory. For example, the internal buffer 123 may include a static random access memory or a dynamic random access memory.

The processor 124 may execute an operating system or firmware for driving the memory controller 120. The processor 124 may read the parsed requests stored in the internal buffer 123 and may generate addresses and commands for controlling the nonvolatile memory device 110. The processor 124 may provide the generated commands and addresses to the memory manager 126.

The processor 124 may store various metadata for managing the storage device 100 in the internal buffer 123. The processor 124 may access the external buffer 130 through the buffer controller 125. The processor 124 may control the buffer controller 125 and the memory manager 126 such that the user data stored in the external buffer 130 are provided to the nonvolatile memory device 110.

The processor 124 may control the host interface 122 and the buffer controller 125 such that the data stored in the external buffer 130 are provided to the external host device. The processor 124 may control the buffer controller 125 and the memory manager 126 such that the data received from the nonvolatile memory device 110 are stored in the external buffer 130. The processor 124 may control the host interface 122 and the buffer controller 125 such that the data received from the external host device are stored in the external buffer 130.

Under control of the processor 124, the buffer controller 125 may write data in the external buffer 130 or may read data from the external buffer 130. The memory manager 126 may communicate with the nonvolatile memory device 110 through the first signal lines SIGL1 and the second signal lines SIGL2 under control of the processor 124.

The memory manager 126 may access the nonvolatile memory device 110 under control of the processor 124. For example, the memory manager 126 may access the nonvolatile memory device 110 through the first signal lines SIGL1 and the second signal lines SIGL2. The memory manager 126 may communicate with the nonvolatile memory device 110, based on a protocol defined in compliance with the standard or defined by a manufacturer.

The error correction code block 127 may perform error correction encoding for data to be provided to the nonvolatile memory device 110 by using the error correction code ECC. The error correction code block 127 may perform error correction decoding for data received from the nonvolatile memory device 110 by using the error correction code ECC.

In some implementations, the external buffer 130 and the buffer controller 125 may be omitted in the storage device 100. When the external buffer 130 and the buffer controller 125 are omitted, the functions which are described as being performed by the external buffer 130 and the buffer controller 125 may be performed by the internal buffer 123.

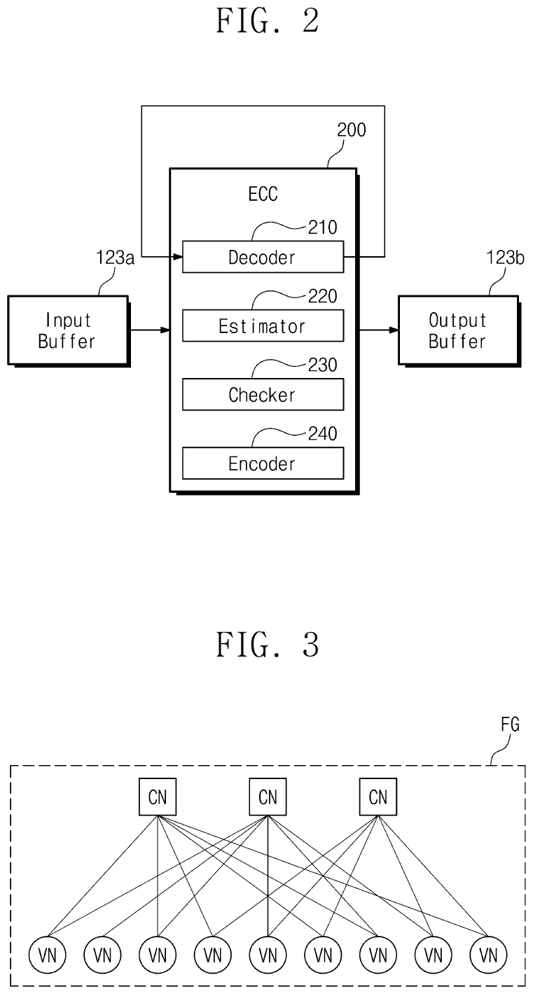

FIG. 2 illustrates an example of an error correction code block 200. Referring to FIGS. 1 and 2, the error correction code block 200 may include a decoder 210, an estimator 220, a checker 230, and an encoder 240.

The decoder 210 may receive data (e.g., first data) for error correction from an input buffer 123a. For example, the first data may refer to data read from the nonvolatile memory device 110. For example, the input buffer 123a may be included in the internal buffer 123. The decoder 210 may generate second data by performing error correction decoding (e.g., an error correction operation) for the first data.

The estimator 220 may perform an estimation operation on the first data or the second data. For example, the estimation operation may include estimating an error level of the first data or the second data. The estimator 220 may estimate the error level of the first data or the second data, based on various information included in the first data or the second data.

For example, the decoder 210 and the estimator 220 may perform iterative decoding and estimation. For example, the decoder 210 may perform low density parity check (LDPC) decoding. Each of iterative error correction loops of the LDPC decoding may be called an error correction operation.

For example, after each error correction operation of the second data is completed, the estimator 220 may estimate the error level of the second data. For example, the estimator 220 may estimate whether the error level of the second data is a level capable of being corrected by one error correction operation. When the error level of the second data is a level capable of being corrected by one error correction operation, the decoder 210 may perform the error correction operation on the second data so as to be output as third data. The error correction code block 200 may store the third data in an output buffer 123b. For example, the output buffer 123b may be included in the internal buffer 123.

The checker 230 may check the integrity of the third data. For example, the checker 230 may check the integrity of the third data while the third data are being output to the output buffer 123b. The operation of checking the integrity may include an operation of checking whether an error is included in the third data.

The encoder 240 may perform error correction encoding for data to be written in the nonvolatile memory device 110. For example, the encoder 240 may perform LDPC encoding. To convey the technical idea of the present disclosure, the detailed description about components and operations associated with the encoder 240 is omitted.

FIG. 3 illustrates an example of a factor graph FG showing an operating principle of the decoder 210. Referring to FIGS. 1, 2, and 3, the factor graph FG may include a plurality of check nodes CN and a plurality of variable nodes VN. Each of the plurality of variable nodes VN may be connected to two or more check nodes CN through edges. The number of edges connected to each variable node may be the degree of the variable node. The plurality of variable nodes may correspond to the first data read from the nonvolatile memory device 110.

The decoder 210 may add a parity bit(s) such that a sum of bits of the variable nodes VN connected to each check node CN is a fixed value, for example, “0” or “1”. The check condition may correspond to the condition that a sum of bits of the variable nodes VN connected to each check node CN is a fixed value (e.g., “0”).

In some implementations, the decoder 210 may perform min-sum decoding. In the min-sum decoding, the decoder 210 may transfer signs and values of the variable nodes VN to the check node CN connected thereto. The decoder 210 may select one of the connected variable nodes VN and may select the smallest value among values transferred from the remaining variable nodes VN other than the selected variable node VN. The decoder 210 may transmit the selected value and an associated sign to the selected variable node VN. The selected variable node VN may add a previously stored value and a previously stored sign to the selected value and the associated signal so as to be stored as a new value.

Each of the check nodes CN may perform the above operation while sequentially selecting the variable nodes VN connected thereto. When values of all the variable nodes VN are updated, one loop of the LDPC decoding may be completed.

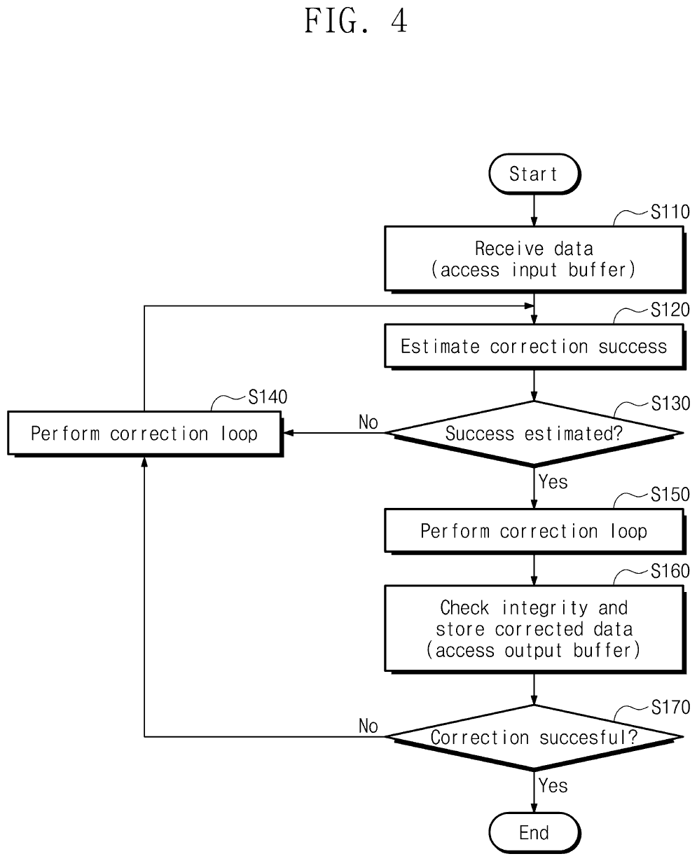

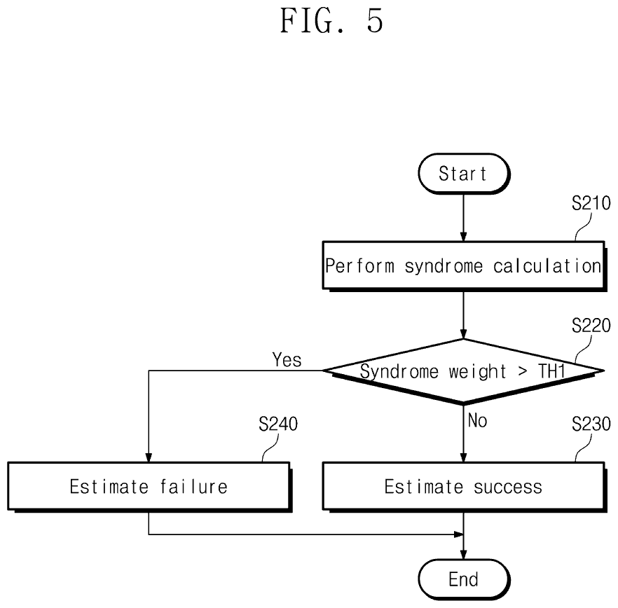

FIG. 4 illustrates an example of an operating method of the error correction code block 200. Referring to FIGS. 1, 2, 3, and 4, in operation S110, the error correction code block 200 may receive data. For example, the decoder 210 of the error correction code block 200 may receive data (e.g., the first data) by accessing (e.g., reading) the input buffer 123a. The received data may be stored at the variable nodes VN of the decoder 210.

In operation S120, the error correction code block 200 may estimate correction success. For example, the estimator 220 of the error correction code block 200 may estimate whether error correction is completed in a next loop of the LDPC decoding (whether all errors are corrected), based on information of the first data or the second data loaded to the decoder 210.

In some implementations, the estimator 220 may estimate whether error correction is completed in a next loop of the LDPC decoding (whether all errors are corrected), by estimating the level of errors of the first data or the second data (or the number of errors thereof). In some implementations, the level of errors of the first data or the second data (or the number of errors thereof) may be estimated based on information of the LDPC decoding executed in the decoder 210 in association with the second data or the information of the first data.

When the success is not estimated in operation S130, in operation S140, the error correction code block 200 may perform a correction loop. For example, when the estimator 220 of the error correction code block 200 estimates that error correction is not completed in a next loop of the LDPC decoding, in operation S140, the decoder 210 of the error correction code block 200 may perform one loop of the LDPC decoding. When one loop of the LDPC decoding is performed, values (or sign values and at least one sign) stored at the variable nodes VN of the decoder 210 may be updated. For example, data stored at the variable nodes VN after the loop of the LDPC decoding is performed may be the second data.

When the success is estimated in operation S130, in operation S150, the error correction code block 200 may perform a correction loop. For example, when the estimator 220 of the error correction code block 200 estimates that error correction is completed in a next loop of the LDPC decoding, in operation S160, the decoder 210 of the error correction code block 200 may perform one loop of the LDPC decoding. When one loop of the LDPC decoding is performed, values (or sign values and at least one sign) stored at the variable nodes VN of the decoder 210 may be updated.

In operation S160, the error correction code block 200 may check the integrity and may store the corrected data (e.g., the third data). In some implementations, the decoder 210 may access (e.g., write) the output buffer 123b by storing the data stored at the variable nodes VN in the output buffer 123b. While the decoder 210 stores the third data in the output buffer 123b, the checker 230 may perform a check operation of checking the integrity of the third data. For example, the store operation in which the decoder 210 stores the third data in the output buffer 123b and the check operation may be simultaneously performed. In some implementations, the integrity check of the checker 230 may include various methods such as CRC check and ECC check.

When the correction is successful in operation S170, the error correction of the error correction code block 200 may be terminated. The error-corrected data may be in a state of being stored in the output buffer 123b. The decoder 210 may delete error correction-associated data stored therein, for example, the third data.

When the correction is not successful in operation S170, in operation S140, the decoder 210 may perform an error correction loop. For example, the decoder 210 may identify the third data generated in a previous loop as the second data and may perform the error correction loop. Afterwards, operation S120 and operation S130 may be sequentially performed.

In some implementations, the memory controller 120 may perform post-processing for the error-corrected data. The post-processing may include derandomize, decryption, etc. The memory controller 120 may further include a derandomizer block for derandomize and a decryption block for decryption.

In some implementations, the derandomizer block and the decryption block may maintain a power-saving state until the error correction of the error correction code block 200 is completed. When the success is estimated in operation S130, the error correction code block 200 may trigger an early termination signal to the derandomizer block and the decryption block. The derandomizer block and the decryption block may wake up in response to the early termination signal. Accordingly, a speed at which the memory controller 120 processes data read from the nonvolatile memory device 110 may be improved.

FIG. 5 is a diagram illustrating a first example in which the estimator 220 performs an estimation operation. Referring to FIGS. 1, 2, 3, 4, and 5, in operation S210, the estimator 220 may calculate a syndrome. For example, the estimator 220 may calculate a syndrome of the first data read from the input buffer 123a or a syndrome of the second data obtained after the decoder 210 completes the LDPC decoding.

In operation S220, the estimator 220 may determine whether a syndrome weight is greater than a first threshold value TH1. For example, the syndrome weight may refer to a number not satisfying a syndrome condition, for example, the number of syndrome polynomials where a calculation result is not “0”, in a syndrome calculation result.

When the syndrome weight is equal to the first threshold value TH1 or is not greater than the first threshold value TH1, in operation S230, the estimator 220 may estimate the success. For example, as the syndrome weight becomes smaller, the number of errors included in data may decrease. Accordingly, when the syndrome weight is equal to or smaller than the first threshold value TH1, the estimator 220 may estimate the error correction success.

When the syndrome weight is greater than the first threshold value TH1, in operation S240, the estimator 220 may estimate the failure. For example, as the syndrome weight becomes greater, the number of errors included in data may increase. Accordingly, when the syndrome weight is greater than the first threshold value TH1, the estimator 220 may estimate the error correction failure.

In some implementations, the estimator 220 may calculate a syndrome of the first data read from the input buffer 123a. When the success is estimated in the first data, the decoder 210 may perform error correction by performing the LDPC decoding (e.g., including a plurality of error correction loops) for the first data once and may output the error-corrected data as the third data without an additional estimation operation.

In some implementations, the estimator 220 may calculate a syndrome of the second data whose error correction is completed by the decoder 210. When the success is estimated in the second data, the decoder 210 may perform error correction by performing the LDPC decoding (e.g., including a plurality of error correction loops) for the second data once and may output the error-corrected data as the third data without an additional estimation operation.

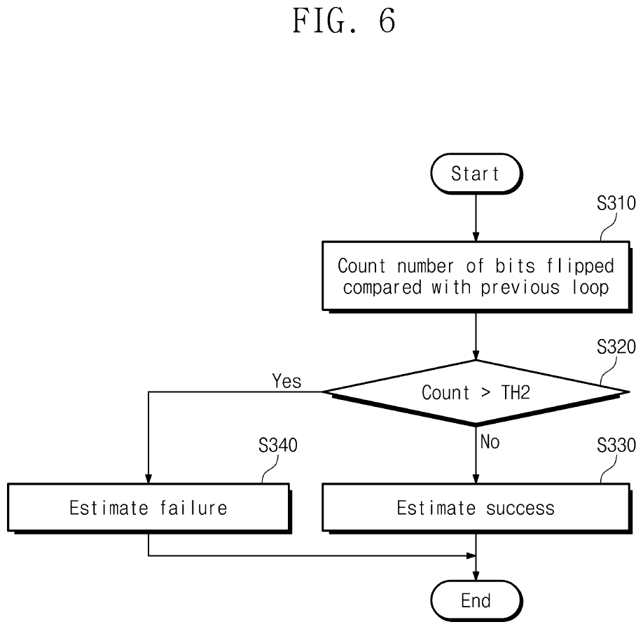

FIG. 6 illustrates a second example in which the estimator 220 performs an estimation operation. Referring to FIGS. 1, 2, 3, 4, and 6, in operation S310, the estimator 220 may count the number of flipped bits, compared with a previous loop. For example, the estimator 220 may count a difference of the number of bits flipped in a first error correction operation (or an error correction loop) and the number of bits flipped in a second error correction operation (or an error correction loop). The first error correction operation may refer to an error correction operation immediately previously performed, and the second error correction operation may refer to an error correction operation performed immediately before the first error correction operation or an error correction operation performed for the first time.

In operation S320, the estimator 220 may determine whether a count is greater than a second threshold value TH2.

When the count is equal to the second threshold value TH2 or is not greater than the second threshold value TH2, in operation S330, the estimator 220 may estimate the success. For example, as the count becomes smaller, the number of errors corrected by the error correction operation (or error correction loop) may decrease. Accordingly, the estimator 220 may determine that the error correction is close to convergence and may estimate the error correction success.

When the count is greater than the second threshold value TH2, in operation S340, the estimator 220 may estimate the failure. For example, as the count becomes greater, the number of errors corrected by the error correction operation (or error correction loop) may increase. Accordingly, the estimator 220 may determine that the error correction is not close to convergence and may estimate the error correction failure.

In some implementations, the estimator 220 may calculate a count of the second data whose error correction is completed by the decoder 210. When the success is estimated in the second data, the decoder 210 may perform error correction by performing the LDPC decoding (e.g., including a plurality of error correction loops) for the second data once and may output the error-corrected data as the third data without an additional estimation operation.

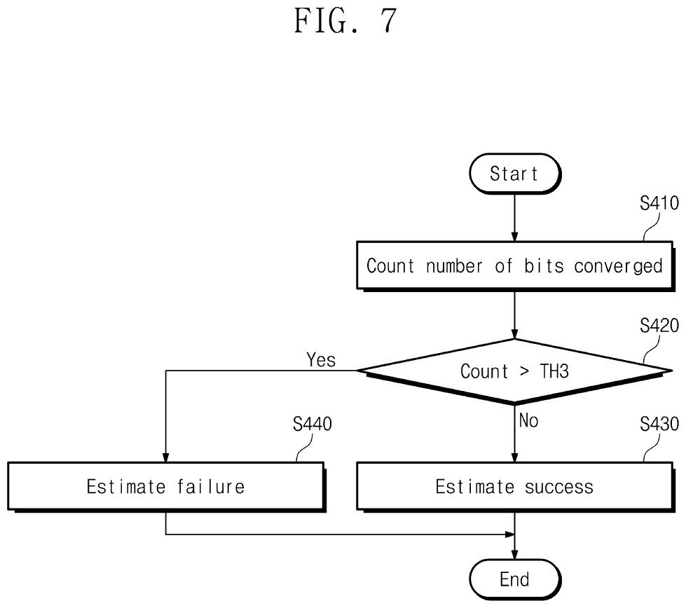

FIG. 7 is a diagram illustrating a third example in which the estimator 220 performs an estimation operation. Referring to FIGS. 1, 2, 3, 4, and 7, in operation S410, the estimator 220 may count the number of converged bits. For example, the estimator 220 may count the number of bits converged from among the bits of the variable nodes VN.

In operation S420, the estimator 220 may determine whether a count is greater than a third threshold value TH3.

When the count is equal to the third threshold value TH3 or is not greater than the third threshold value TH3, in operation S430, the estimator 220 may estimate the success. For example, as the count becomes greater, the number of bits determined by the error correction operation (or the error correction loop) as being not erroneous may increase. Accordingly, the estimator 220 may determine that the error correction is close to convergence and may estimate the error correction success.

When the count is greater than the third threshold value TH3, in operation S440, the estimator 220 may estimate the failure. For example, as the count becomes smaller, the number of bits determined as being not erroneous may decrease. Accordingly, the estimator 220 may determine that the error correction is not close to convergence and may estimate the error correction failure.

In some implementations, the estimator 220 may calculate a count of the second data whose error correction is completed by the decoder 210. When the success is estimated in the second data, the decoder 210 may perform error correction by performing the LDPC decoding (e.g., including a plurality of error correction loops) for the second data once and may output the error-corrected data as the third data without an additional estimation operation.

For example, at least some of the implementations of the estimation operation described with reference to FIGS. 5, 6, and 7 may be performed together. For example, two or more implementations may be used together with the estimation operation. Assuming that two or more implementations are used in the estimation operation, the correction success may be estimated when all conditions of the two or more implementations are satisfied or when one of the conditions of the two or more implementations is satisfied. As another example, odd-numbered implementations may be applied to the estimation operation, and voting may be performed based on how many conditions of the odd-numbered implementations are satisfied. When a result of the voting indicates the correction success, the correction success may be estimated.

The implementations of the estimation operation are described with reference to FIGS. 5, 6, and 7. However, a method of performing the estimation operation is not limited to the implementations disclosed in FIGS. 5, 6, and 7. The estimation operation may be differently implemented depending on the structure and operating method of the error correction code block 200 and various matrices used in the error correction code block 200.

In some implementations, the estimator 220 may perform the estimation operation by comparing the trend of the minimum value or the maximum value among values respectively transferred to the check nodes CN with a threshold value. The estimator 220 may perform the estimation operation by comparing the threshold value with values (sum values) and signs (sum signs) of the variable nodes VN or the trend of the values and the trend of the signs. The estimation operation based on the check nodes CN and the variable nodes VN of the factor graph FG may change depending on a structure of the factor graph FG, a structure of a generator matrix, etc.

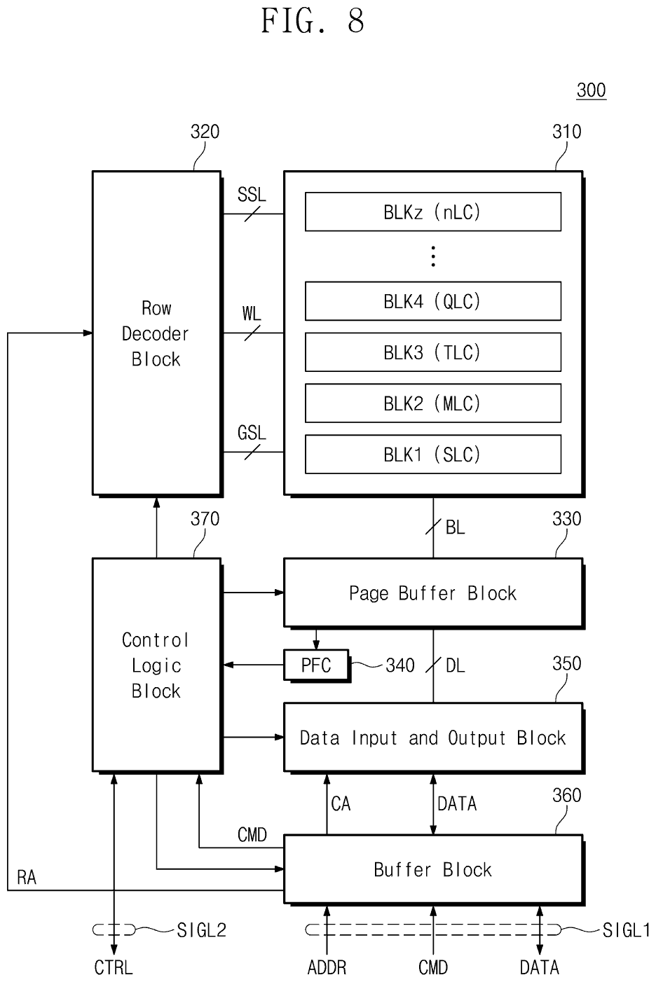

FIG. 8 is a block diagram illustrating an example of a nonvolatile memory device 300. Referring to FIG. 2, the nonvolatile memory device 300 includes a memory cell array 310, a row decoder block 320, a page buffer block 330, a pass/fail check block (PFC) 340, a data input and output block 350, a buffer block 360, and a control logic block 370.

The memory cell array 310 includes a plurality of memory blocks BLK1 to BLKz. Each of the memory blocks BLK1 to BLKz includes a plurality of memory cells. Each of the memory blocks BLK1 to BLKz may be connected to the row decoder block 320 through at least one ground selection line GSL, word lines WL, and at least one string selection line SSL. Some of the word lines WL may be used as dummy word lines. Each of the memory blocks BLK1 to BLKz may be connected to the page buffer block 330 through a plurality of bit lines BL. The plurality of memory blocks BLK1 to BLKz may be connected in common to the plurality of bit lines BL.

In some implementations, each of the plurality of memory blocks BLK1 to BLKz may correspond to a unit of the erase operation. Memory cells belonging to each memory block may be erased at the same time. As another example, each of the memory blocks BLK1 to BLKz may be divided into a plurality of sub-blocks. Each of the plurality of sub-blocks may correspond to a unit of the erase operation. The row decoder block 320 is connected to the memory cell array 310 through the ground selection lines GSL, the word lines WL, and the string selection lines SSL. The row decoder block 320 operates under control of the control logic block 370.

The row decoder block 320 may decode a row address RA received from the buffer block 360 and may control voltages to be applied to the string selection lines SSL, the word lines WL, and the ground selection lines GSL based on the decoded row address.

The page buffer block 330 is connected to the memory cell array 310 through the plurality of bit lines BL. The page buffer block 330 is connected to the data input and output block 350 through a plurality of data lines DL. The page buffer block 330 operates under control of the control logic block 370.

In the program operation, the page buffer block 330 may store data to be written in memory cells. The page buffer block 330 may apply voltages to the plurality of bit lines BL based on the stored data. In the read operation or in the verify read operation that is performed in the program operation or the erase operation, the page buffer block 330 may sense voltages of the bit lines BL and may store a sensing result.

In the verify read operation associated with the program operation or the erase operation, the pass/fail check block 340 may verify the sensing result of the page buffer block 330. For example, in the verify read operation that is performed in the program operation, the pass/fail check block 340 may count the number of values (e.g., the number of Os) corresponding to on-cells that are not programmed to a target threshold voltage or higher.

In the verify read operation that is performed in the erase operation, the pass/fail check block 340 may count the number of values (e.g., the number of 1s) corresponding to off-cells that are not erased to a target threshold voltage or lower. When a counting result is greater than or equal to a threshold value, the pass/fail check block 340 may output a fail signal to the control logic block 370. When the counting result is smaller than the threshold value, the pass/fail check block 340 may output a pass signal to the control logic block 370. Depending on the verification result of the pass/fail check block 340, a program loop of the program operation may be further performed, or an erase loop of the erase operation may be further performed.

The data input and output block 350 is connected to the page buffer block 330 through the plurality of data lines DL. The data input and output block 350 may receive a column address CA from the buffer block 360. The data input and output block 350 may output the data read by the page buffer block 330 to the buffer block 360 depending on the column address CA. The data input and output block 350 may provide the data received from the buffer block 360 to the page buffer block 330, based on the column address CA.

Through the first signal lines SIGL1, the buffer block 360 may receive a command CMD and an address ADDR from an external device and may exchange data “DATA” with the external device. The buffer block 360 may operate under control of the control logic block 370. The buffer block 360 may provide the command CMD to the control logic block 370. The buffer block 360 may provide the row address RA of the address ADDR to the row decoder block 320 and may provide the column address CA of the address ADDR to the data input and output block 350. The buffer block 360 may exchange the data “DATA” with the data input and output block 350.

The control logic block 370 may exchange a control signal CTRL with the external device through the second signal lines SIGL2. The control logic block 370 may allow the buffer block 360 to route the command CMD, the address ADDR, and the data “DATA”. The control logic block 370 may decode the command CMD received from the buffer block 360 and may control the nonvolatile memory device 300 based on the decoded command.

In some implementations, the nonvolatile memory device 300 may be manufactured in a bonding method. The memory cell array 310 may be manufactured by using a first wafer, and the row decoder block 320, the page buffer block 330, the pass/fail check block 340, the data input and output block 350, the buffer block 360, and the control logic block 370 may be manufactured by using a second wafer. The nonvolatile memory device 300 may be implemented by coupling the first wafer and the second wafer such that an upper surface of the first wafer and an upper surface of the second wafer face each other.

As another example, the nonvolatile memory device 300 may be manufactured in a cell over peri (COP) method. A peripheral circuit including the row decoder block 320, the page buffer block 330, the pass/fail check block 340, the data input and output block 350, the buffer block 360, and the control logic block 370 may be implemented on a substrate. The memory cell array 310 may be implemented over the peripheral circuit. The peripheral circuit and the memory cell array 310 may be connected by using through vias.

In some implementations, the plurality of memory blocks BLK1 to BLKz may be used to store data with different densities. For example, the memory cells of the first memory block BLK1 may be used as a single level cell (SLC) which stores one bit. The memory cells of the second memory block BLK2 may be used as a multi-level cell (MLC) which stores two bits.

The memory cells of the third memory block BLK3 may be used as a triple level cell (TLC) which stores three bits. The memory cells of the fourth memory block BLK4 may be used as a quad-level cell (QLC) which stores four bits. The memory cells of the z-th memory block BLKz may be used as an n-level cell (nLC) which stores n bits.

As the number of bits stored in one memory cell increases, the probability that an error occurs in the stored data may increase. As the number of bits stored in one memory cell decreases, the probability that an error occurs in the stored data may decrease. In the nonvolatile memory device of FIG. 8, the probability that an error occurs in data stored in the first memory block BLK1 including the SLCs may be the lowest.

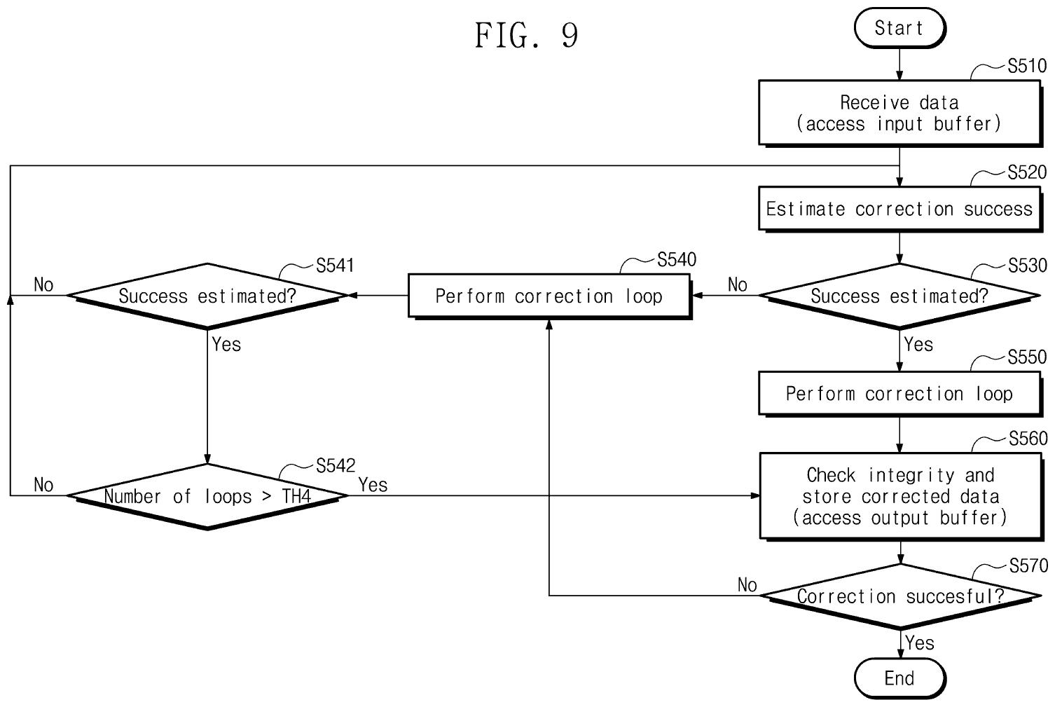

FIG. 9 illustrates an example of an operating method of the error correction code block 200. Referring to FIGS. 1, 2, 3, 8, and 9, in operation S510, the error correction code block 200 may receive data. For example, the decoder 210 of the error correction code block 200 may receive data (e.g., the first data) by accessing (e.g., reading) the input buffer 123a. The received data may be stored at the variable nodes VN of the decoder 210.

In operation S520, the error correction code block 200 may estimate correction success. For example, the estimator 220 of the error correction code block 200 may estimate whether error correction (e.g., the correction of all errors) will be completed in a next loop of the LDPC decoding, based on information of the first data loaded to the decoder 210.

When the success is not estimated in operation S530, in operation S540, the error correction code block 200 may perform a correction loop. For example, when the estimator 220 of the error correction code block 200 estimates that error correction is not completed in a next loop of the LDPC decoding, in operation S540, the decoder 210 of the error correction code block 200 may perform one loop of the LDPC decoding. When one loop of the LDPC decoding is performed, values (or sign values and at least one sign) stored at the variable nodes VN of the decoder 210 may be updated. Afterwards, operation S541 is performed.

In operation S541, the error correction code block 200 may determine whether the first data read from the input buffer 123a are SLC data. For example, whether the first data are SLC data may be determined depending on whether a memory block of the nonvolatile memory device 300, from which the first data are read, is an SLC memory block. For example, the control logic block 370 may determine whether the first data are SLC data, based on the address ADDR. Afterwards, the control logic block 370 may provide the error correction code block 200 with information or a signal indicating whether the first data are SLC data.

When the first data are not SLC data, the error correction code block 200 may perform operation S520 and operation S530. When the first data are SLC data, in operation S542, the decoder 210 may determine whether the number of loops is greater than a fourth threshold value TH4. When the number of loops is greater than the fourth threshold value TH4, the error correction code block 200 may perform operation S560 and operation S570. When the number of loops is equal to or smaller than the fourth threshold value TH4, the error correction code block 200 may perform operation S520 and operation S530.

When the success is estimated in operation S530, in operation S550, the error correction code block 200 may perform a correction loop. For example, when the estimator 220 of the error correction code block 200 estimates that error correction is completed in a next loop of the LDPC decoding, in operation S560, the decoder 210 of the error correction code block 200 may perform one loop of the LDPC decoding. When one loop of the LDPC decoding is performed, values (or sign values and at least one sign) stored at the variable nodes VN of the decoder 210 may be updated.

In operation S560, the error correction code block 200 may check the integrity and may store the corrected data (e.g., the third data). In some implementations, the decoder 210 may access (e.g., write) the output buffer 123b by storing the data stored at the variable nodes VN in the output buffer 123b. While the decoder 210 stores the third data in the output buffer 123b, the checker 230 may perform a check operation of checking the integrity of the third data. For example, the store operation in which the decoder 210 stores the third data in the output buffer 123b and the check operation may be simultaneously performed. In some implementations, the integrity check of the checker 230 may include various methods such as CRC check and ECC check.

When the correction is successful in operation S570, the error correction of the error correction code block 200 may be terminated. The error-corrected data may be in a state of being stored in the output buffer 123b. The decoder 210 may delete error correction-associated data stored therein, for example, the third data.

When the correction is not successful in operation S570, in operation S540, the decoder 210 may perform an error correction loop. For example, the decoder 210 may identify the third data generated in a previous loop as the second data and may perform the error correction loop. Afterwards, operation S520 and operation S530 may be sequentially performed.

In some implementations, the number of errors which the SLC data have may be relatively small. Accordingly, when the error correction operation (or loop) is executed in a state of exceeding the fourth threshold value TH4, all the errors of the SLC data may be regarded as being corrected. Accordingly, the error correction code block 200 may check the integrity of the third data being the SLC data and may store the corrected third data in the output buffer 123b.

In some implementations, the memory controller 120 may perform post-processing for the error-corrected data. The post-processing may include derandomize, decryption, etc. The memory controller 120 may further include a derandomizer block for derandomize and a decryption block for decryption.

In some implementations, the derandomizer block and the decryption block may maintain a power-saving state until the error correction of the error correction code block 200 is completed. When the success is estimated in operation S530 or when it is determined in operation S542 that the number of loops is greater than the fourth threshold value TH4, the error correction code block 200 may trigger the early termination signal to the derandomizer block and the decryption block. The derandomizer block and the decryption block may wake up in response to the early termination signal. Accordingly, a speed at which the memory controller 120 processes data read from the nonvolatile memory device 110 may be improved.

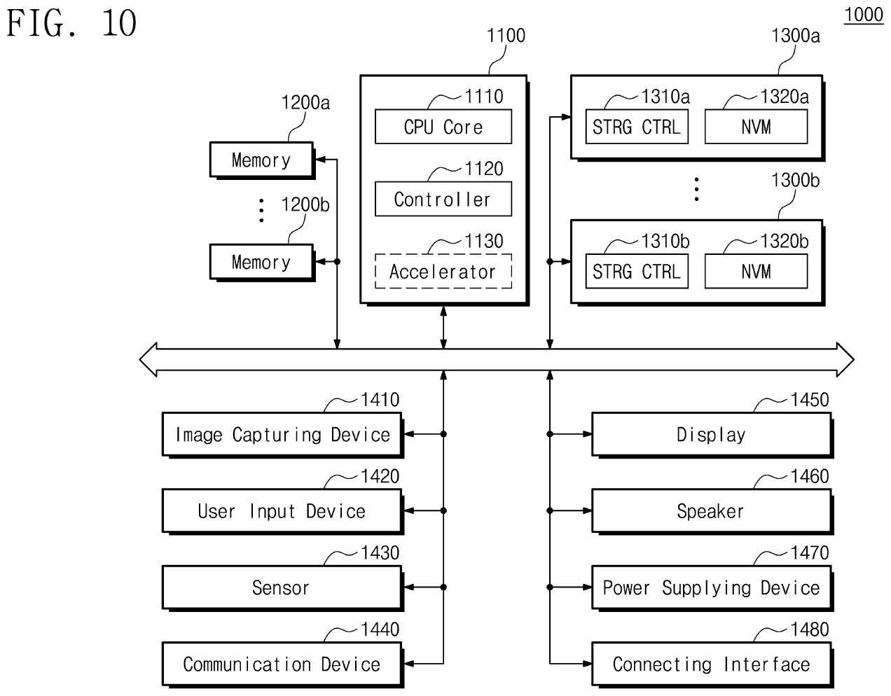

FIG. 10 is a diagram of an example of a system 1000 to which a storage device is applied. The system 1000 of FIG. 10 may basically be a mobile system, such as a portable communication terminal (e.g., a mobile phone), a smartphone, a tablet personal computer (PC), a wearable device, a healthcare device, or an Internet of things (IoT) device. However, the system 1000 of FIG. 10 is not necessarily limited to the mobile system and may be a PC, a laptop computer, a server, a media player, or an automotive device (e.g., a navigation device).

Referring to FIG. 10, the system 1000 may include a main processor 1100, memories (e.g., 1200a and 1200b), and storage devices (e.g., 1300a and 1300b). In addition, the system 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000, more specifically, operations of other components included in the system 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some implementations, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the system 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVM (Non-Volatile Memory) s 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000 or implemented in the same package as the main processor 1100. In addition, the storage devices 1300a and 1300b may have types of solid-state devices (SSDs) or memory cards and be removably combined with other components of the system 1000 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000 and include a touch pad, a keypad, a keyboard, a mouse, and/or a microphone.

The sensor 1430 may detect various types of physical quantities, which may be obtained from the outside of the system 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000 according to various communication protocols. The communication device 1440 may include an antenna, a transceiver, and/or a modem.

The display 1450 and the speaker 1460 may serve as output devices configured to respectively output visual information and auditory information to the user of the system 1000.

The power supplying device 1470 may appropriately convert power supplied from a battery embedded in the system 1000 and/or an external power source, and supply the converted power to each of components of the system 1000.

The connecting interface 1480 may provide connection between the system 1000 and an external device, which is connected to the system 1000 and capable of transmitting and receiving data to and from the system 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In some implementations, the storage device 100 described with reference to FIGS. 1 to 9 may be implemented with the storage devices 1300a and 1300b. The storage device 100 may include the nonvolatile memory device 110 and the memory controller 120. When error correction of data read from the nonvolatile memory device 110 is estimated as being successful in a next error correction loop, the memory controller 120 may perform the error correction loop and integrity check and store of the error-corrected data. When error correction of data read from the nonvolatile memory device 110 is estimated as failing in a next error correction loop, the memory controller 120 may perform only the error correction loop. Accordingly, the power consumption of the storage device 100 may be reduced.

In the above implementations, components according to the present disclosure are described by using the terms “first”, “second”, “third”, etc. However, the terms “first”, “second”, “third”, etc. may be used to distinguish components from each other and do not limit the present disclosure. For example, the terms “first”, “second”, “third”, etc. do not involve an order or a numerical meaning of any form.

In the above implementations, components according to implementations of the present disclosure are referenced by using blocks. The blocks may be implemented with various hardware devices, such as an integrated circuit, an application specific IC (ASIC), a field programmable gate array (FPGA), and a complex programmable logic device (CPLD), firmware driven in hardware devices, software such as an application, or a combination of a hardware device and software. Also, the blocks may include circuits implemented with semiconductor elements in an integrated circuit, or circuits enrolled as an intellectual property (IP).

According to implementations of the present disclosure, at least some of operations of an error correction code block including an integrity check operation and an operation of storing error correction-decoded data in a buffer are omitted. Accordingly, a storage device with reduced power consumption and an operating method of the storage device are provided.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A storage device comprising:
a nonvolatile memory device; and
a memory controller configured to control the nonvolatile memory device,
wherein the memory controller includes:
an internal buffer configured to store first data read from the nonvolatile memory device; and
an error correction code block configured to
read the first data from the internal buffer,
correct an error of the first data,
perform an error correction operation that performs an error correction loop for the first data,
perform an estimation operation that estimates an error level of second data, the second data being obtained as an execution result of the error correction loop for the first data,
based on the error level estimated in the estimation operation being uncorrectable in a next error correction operation, perform the next error correction operation and the estimation operation, and
based on the error level being correctable in the next error correction operation, perform the next error correction operation and perform a check operation that checks integrity of third data used in the next error correction operation.

2. The storage device of claim 1, wherein the error correction code block is configured to omit the check operation based on the error level being uncorrectable in the next error correction operation.

3. The storage device of claim 1, wherein the error correction code block is configured to, based on the error level being correctable in the next error correction operation, perform a store operation that stores the third data in the internal buffer.

4. The storage device of claim 3, wherein the check operation and the store operation are performed in parallel.

5. The storage device of claim 1, wherein the error correction code block is configured to, based on an error being detected in the check operation, perform the error correction operation and the estimation operation on the third data.

6. The storage device of claim 1, wherein the error correction code block is configured to delete the third data based on an error being not detected in the check operation.

7. The storage device of claim 1, wherein the error correction code block is configured to trigger an early termination signal based on the error level being correctable in the next error correction operation.

8. The storage device of claim 1, wherein the estimation operation is performed based on a syndrome weight.

9. The storage device of claim 8, wherein the error correction code block is configured to, based on the syndrome weight being equal to or smaller than a first threshold value, estimate that the error level is correctable in the next error correction operation.

10. The storage device of claim 1, wherein the estimation operation is performed based on the number of bits inverted in the third data.

11. The storage device of claim 10, wherein the error correction code block is configured to, based on a count corresponding to a difference between the number of bits inverted in a first error correction operation and the number of bits inverted in a second error correction operation being greater than a second threshold value, estimate that the error level is correctable in the next error correction operation.

12. The storage device of claim 11, wherein the first error correction operation is a last performed error correction operation, and
wherein the second error correction operation is an error correction operation performed immediately before the first error correction operation or an error correction operation performed for the first time.

13. The storage device of claim 1, wherein the estimation operation is performed based on the number of bits converged in the third data.

14. The storage device of claim 13, wherein the error correction code block is configured to, based on the number of bits converged in the error correction operation being greater than a third threshold value, estimate that the error level is correctable in the next error correction operation.

15. The storage device of claim 1, wherein the error correction code block is configured to perform low density parity check (LDPC) decoding, and
wherein the error correction operation corresponds to one loop of the LDPC decoding.

16. The storage device of claim 15, wherein the error correction code block is configured to perform min-sum decoding, and
wherein the estimation operation is performed based on at least one of minimum values or sum values of the min-sum decoding.

17. The storage device of claim 1, wherein the error correction code block is configured to, based on the first data being single level cell (SLC) data, perform the check operation after the error correction operation is performed up to a fourth threshold value.

18. The storage device of claim 17, wherein the error correction code block is configured to, based on the first data being single level cell (SLC) data, perform the check operation without the estimation operation after the error correction operation is performed up to the fourth threshold value.

19. An operating method of a storage device that includes a nonvolatile memory device and a memory controller, the method comprising:
reading, at the memory controller, first data from the nonvolatile memory device;
performing, at the memory controller, an error correction operation on the first data to generate second data;
performing, at the memory controller, an error estimation operation on the second data;
based on an error level estimated in the error correction operation being uncorrectable in a next error correction operation, performing, at the memory controller, the next error correction operation and the error estimation operation; and
based on the error level being correctable in the next error correction operation, performing, at the memory controller, the next error correction operation and an integrity estimation operation on the second data.

20. A memory system comprising:
a nonvolatile memory device; and
a memory controller configured to control the nonvolatile memory device,
wherein the memory controller includes:
an internal buffer configured to store first data read from the nonvolatile memory device; and
an error correction code block configured to
read the first data from the internal buffer,
correct an error of the first data,
perform an error correction operation that performs an error correction loop for the first data,
perform an estimation operation that estimates an error level of second data, the second data being obtained as an execution result of the error correction loop for the first data,
based on the error level estimated in the estimation operation being uncorrectable in a next error correction operation, perform the next error correction operation and the estimation operation,
based on the error level being correctable in the next error correction operation, perform the next error correction operation, and perform a check operation that checks integrity of third data used in the next error correction operation,
based on the error level being uncorrectable in the next error correction operation, omit the check operation, and
based on an error being detected in the check operation, perform the error correction operation and the estimation operation on the third data.
